(19) United States
(12) Patent Application Publication
(10) Pub. No.: US 2018/0316145 A1
(43) Pub. Date: Nov. 1, 2018

(54) FLAT ELECTRICAL PLUG WITH CHILD SAFETY FEATURE

(71) Applicant: GTB Solutions, LLC, West Palm Beach, FL (US)

(72) Inventors: Glenn C. MCKIERNAN, Delray Beach, FL (US); Robert J. BLAIR, West Palm Beach, FL (US); Patricia MURPHY, West Palm Beach, FL (US)

(21) Appl. No.: 15/581,816

(22) Filed: Apr. 28, 2017

(51) Int. Cl. H01R 25/00; H01R 13/717; H01R 13/453; H02G 3/18; H02G 3/10

(52) U.S. Cl. CPC H01R 25/006; H01R 13/7172; H02G 3/10; H01R 13/453; H02G 3/18; H01R 13/7175

(57) ABSTRACT

A device, system, and method for connecting a peripheral device to a power source. The device may include a housing including a first portion coupled to a second portion, the first portion including a face portion and an edging portion, the edging portion edging portion defining the housing thickness. The housing may have an internal chamber, within which may be a circuitry component, at least a portion of at least one plug component, at least one connection port in the housing edging portion, and a light source within the housing interior chamber. Further, each connection port may have a connection port cover that is configured to selectively obstruct or unobstruct the connection port by the application of a minimum amount of activation force against the connection port cover.

### CROSS-REFERENCE TO RELATED APPLICATION

n/a

### STATEMENT REGARDING FEDERALLY SPONSORED RESEARCH OR DEVELOPMENT

n/a

### TECHNICAL FIELD

The present invention relates to a method and system for connecting an electronically operated device to a power source. In particular, the present invention relates to an electrical outlet that provides an interface between an electrical device and a power source.

### BACKGROUND

Many electrical devices are connectable to a power source through, for example, a standard wall outlet or socket. For example, an electrical device may include a cord with a plug that can be inserted into a wall socket to be connected to a power source. However, when plugged in, the plugs typically extend from the wall socket by a distance of up to three inches. If the plug and socket are located behind an item of furniture, for example, that item of furniture must be moved a distance from the wall that will accommodate the protruding plug. This is not only aesthetically displeasing, but also reduces the usable size of a room.

To overcome these disadvantages, flat plugs may be used. For example, a device may have a cord with a flat plug that extends a minimal distance from the wall socket (for example, about half of an inch to one inch). Although such plugs allow an item of furniture to be positioned closer to the wall on which the socket is located, a user must still move the furniture initially to plug the cord into the wall socket. For example, if the wall socket is located behind a couch, the user must first move the couch away from the wall, plug in the cord, and then replace the couch.

Further, even if the wall socket is accessible without having to move the item of furniture, its location may still be inconvenient for frequent use. For example, the wall socket may be located under a desk, requiring the user to bend over and go under the desk to plug or unplug the cord. To overcome this disadvantage, a power strip or extension cord may be used. Hover, these are not only unsightly, but they typically become tangled with the user's feet or stepped on, which can create a dangerous electrical situation.

Finally, most plugs, flat or otherwise, can be easily removed from the wall socket or other socket, which presents a hazard to small children. For example, a power strip or extension cord has exposed sockets that are easily accessible. Although socket covers are known, these covers can be easily removed, even by small children, and therefore present only a minimal safety advantage, at best.

### SUMMARY

The present invention advantageously provides a device, system, and method for connecting a peripheral device to a power source. The device may include a housing including a first portion coupled to a second portion, the first portion including a face portion and an edging portion, the edging portion edging portion defining the housing thickness. The housing may have an internal chamber, within which may be a circuitry component, at least a portion of at least one plug component, at least one connection port in the housing edging portion, and a light source within the housing interior chamber. Further, each connection port may have a connection port cover that is configured to selectively obstruct or unobstruct the connection port by the application of a minimum amount of activation force against the connection port cover.

In one embodiment, a device for connecting to a power source may include: a housing including a first surface, a second surface opposite the first surface, and a third surface between the first and a second surfaces, the first, second, and third surfaces defining a housing interior chamber; at least one plug component extending from the second surface; at least one connection port in the third surface; and a circuitry component within the housing interior chamber.

In one aspect of the embodiment, the housing further includes a first portion and a second portion, the first portion defining the first surface of the housing and the second portion defining the second surface of the housing. In one aspect of the embodiment, the first portion further defines the third surface. In a further aspect of the embodiment, the at least one plug component has a plurality of prongs and the second portion has a plurality of plug apertures, each of the at least one plurality of prongs extending through a corresponding one of the plurality of plug apertures.

In one aspect of the embodiment, at least a portion of the plug component is coupled to the circuit component.

In one aspect of the embodiment, the device further includes a light source at least partially within the housing interior chamber. In one aspect of the embodiment, the housing further includes a light transmission window and the first surface has an aperture sized and configured to accept at least a portion of the light transmission window. In a further aspect of the embodiment, the light source includes a plurality of light emitting diodes.

In one aspect of the embodiment, the device further includes at least one connection port cover. In one aspect of the embodiment, the at least one connection port includes a plurality of connection ports and the at least one connection port cover includes a plurality of connection port covers, each of the plurality of connection port covers being configured to selectively obstruct and unobstruct an associated one of the plurality of connection ports. In one aspect of the embodiment, each of the plurality of connection port covers is configured to move between a first location in which the associated one of the plurality of connection ports is unobstructed and a second location in which the associated one of the plurality of connection ports is obstructed by an application of a minimum amount of depressive force on each of the plurality of connection port covers. In one aspect of the embodiment, the minimum amount of force is at least 5 lbs. In another aspect of the embodiment, the minimum amount of force is approximately 15 lbs.

In one aspect of the embodiment, each of the at least one connection port has a corresponding connection port housing, each connection port housing having a plurality of tracks.

In one aspect of the embodiment, each of the plurality of tracks is at least substantially linear. In one aspect of the embodiment, the plurality of tracks includes a first track on a first side of a corresponding connection port and a second track on a second side opposite the first side of the corresponding connection port. In a further aspect of the embodiment, at least a portion of each of the plurality of connection port covers is configured to be accepted within a corresponding one of the plurality of tracks.

In one embodiment, a device for connecting to a power source may include: at least one electrical connection port; and at least one electrical connection port assembly at each of the at least one electrical connection port, each of the at least one electrical connection port assembly including: an electrical connection port housing having a first track and a second track at least substantially parallel to each other, the first track being on a first side of the electrical connection port and the second track being on a second side of the electrical connection port; an electrical connection port cover having a first protrusion extending away from the electrical connection port cover in a first direction, a second protrusion extending away from the electrical connection port cover in a second direction opposite the first direction, an indentation between the first and second protrusions, the first protrusion being configured to move linearly within the first track and the second protrusion being configured to move linearly within the second track; a post that is slidable relative to the electrical connection port housing, the post being sized and configured such that at least a portion of the port is received within the indentation of the electrical connection port cover; and a spring between the electrical connection port housing and the electrical connection port cover, the spring being wound around at least a portion of the post, the spring having a spring rate that requires a threshold amount of force to compress the spring, each of the at least one electrical connection port cover assembly being configured such that the electrical connection port cover compresses the spring and moves toward the electrical connection port when a depressive force is applied on the electrical connection port cover.

In one aspect of the embodiment, each of the at least one electrical connection port housing further includes a first set of notches in communication with the first and second tracks and a second set of notches a distance from the first set of notches and in communication with the first and second tracks, the first and second protrusions being configured to be: located within the first set of notches when the spring is uncompressed and the electrical connection port is unobstructed by the electrical connection port cover; and located within the second set of notches when the spring is uncompressed and the electrical connection port is obstructed by the electrical connection port cover.

In one embodiment, a kit for connecting a peripheral device to a power source may include: a power source interface device including: a housing having a first surface, a second surface opposite the first surface, and a third surface between the first and a second surfaces, the first, second, and third surfaces defining a housing interior chamber; at least one plug component extending from the second surface; and at least one connection port in the third surface; and at least one extension cable, each of the at least one extension cable including: a first end and a second end opposite the first end; a male connector at the first end; and a female connection port element at the second end, the male connector being configured to be accepted within a corresponding one of the at least one connection port.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a front perspective view of an embodiment of a power source interface device;

FIG. 2 shows a rear perspective view of the power source interface device of FIG. 1;

FIG. 3 shows an exploded view of the power source interface device of FIG. 1;

FIG. 4 shows a front perspective view of a further embodiment of a power source interface device;

FIG. 5 shows a rear perspective view of the power source interface device of FIG. 4;

FIG. 6 shows a side view of the power source interface device of FIG. 4;

FIG. 7 shows an exemplary system including a power source interface device;

FIG. 8 shows an exploded view of an exemplary connection port cover assembly;

FIGS. 9-11 show the connection port cover assembly of FIG. 8 in an open first position;

FIGS. 12-14 show the connection port cover assembly of FIG. 8 in a depressed second position; and

FIGS. 15-17 show the connection port cover assembly of FIG. 8 in a closed third position.

### DETAILED DESCRIPTION

The invention advantageously provides a device, system, and method for connecting a peripheral device to a power source. For example, a device for connecting a peripheral device to a power source may include a housing having an edging portion in which at least one connection port is located. Each connect port may have a connection port cover that can be moved from an open first location to a closed second location. When the connection port cover is in the closed second position, access to the connection ports, and therefore the power supply, is prevented. As a safety feature, it may take a minimum force to move the connection port cover to the open first position from the closed second position. As a non-limiting example, it may require at least 28 pounds of force to open the connection port cover. The device may further include a light source to illuminate dark areas near the device and/or for use as a night light.

Before describing in detail exemplary embodiments that are in accordance with the disclosure, it is noted that components have been represented where appropriate by conventional symbols in drawings, showing only those specific details that are pertinent to understanding the embodiments of the disclosure so as not to obscure the disclosure with details that will be readily apparent to those of ordinary skill in the art having the benefit of the description herein.

As used herein, relational terms, such as “first,” “second,” “top,” “bottom,” “upper,” “lower,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a,” “an,” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Referring now to the drawing figures in which like reference designations refer to like elements, an embodiment of a power source interface device is shown in the figures and generally designated as “10.” The power source interface device may be configured to connect one or more peripheral devices to a power source, and may generally include a housing 12, a plug component 14, at least one connection port 16, and at least one printed circuit board (PCB) or circuit component 18. The housing may have a height H, a width W, and a thickness T. The thickness T may be less than the height H and width W. Further, the thickness T may be less than the length or thickness of a typical electrical plug, meaning the housing 12 is closer to, for example, the wall outlet into which it is plugged than the typical electrical plug. Additionally, the power source interface device 10 may have a plurality of connection ports 16 on its edge rather than on its face, in contrast to typical wall outlets into which the device may be plugged. Accordingly, furniture may be arranged more closely to the wall on which the wall outlet is located when using the power source interface device 10 instead of a typical electrical plug. Thus, the power source interface device 10 may be referred to as being flat or relatively flat in order to distinguish it from known plugs or other electrical outlet devices.

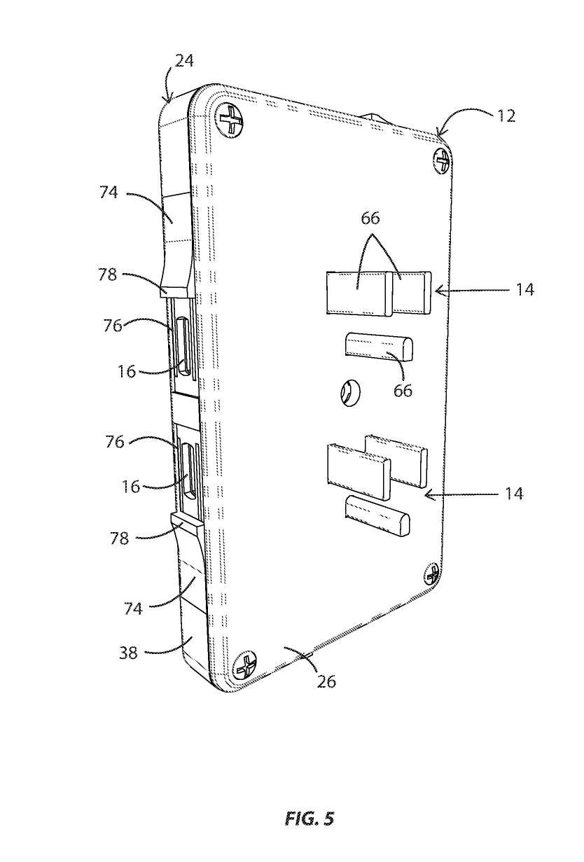

Generally, the housing 12 may include a first surface, a second surface opposite the first surface, and a third (peripheral) surface between the first and second surfaces, the first, second, and third surfaces defining a housing interior chamber. At least a portion of the plug component 14 may extend from the second surface of the housing 12. Additionally, the housing may include one or more connection ports 16 in the third surface. More specifically, the housing 12 may include a first portion 24, which may define the first and third surfaces, and a second portion 26, which may define the second surface. Further, the first 24 and second 26 portions may be configured to be coupled to each other to define an enclosed internal chamber within the housing. As a non-limiting example, each of the first 24 and second 26 portions may include a rim or edge 30 that is configured to be matably attached to the corresponding rim or edge of the other portion. The rim or edge 30A of the first portion 24 and the rim or edge 30B of the second portion 26 may be configured to be coupled to each other by one or more engageable components (such as snaps, tongue and groove couplings, or the like), adhesives, welding, friction fitting, or by other suitable means for ensuring the first 24 and second 26 portions remain coupled to each other when the device 10 is in use. Additionally or alternatively, the first 24 and second 26 portions may be coupled together using screws (for example, as shown in FIG. 5). The housing 12 may be composed of any suitable rigid material

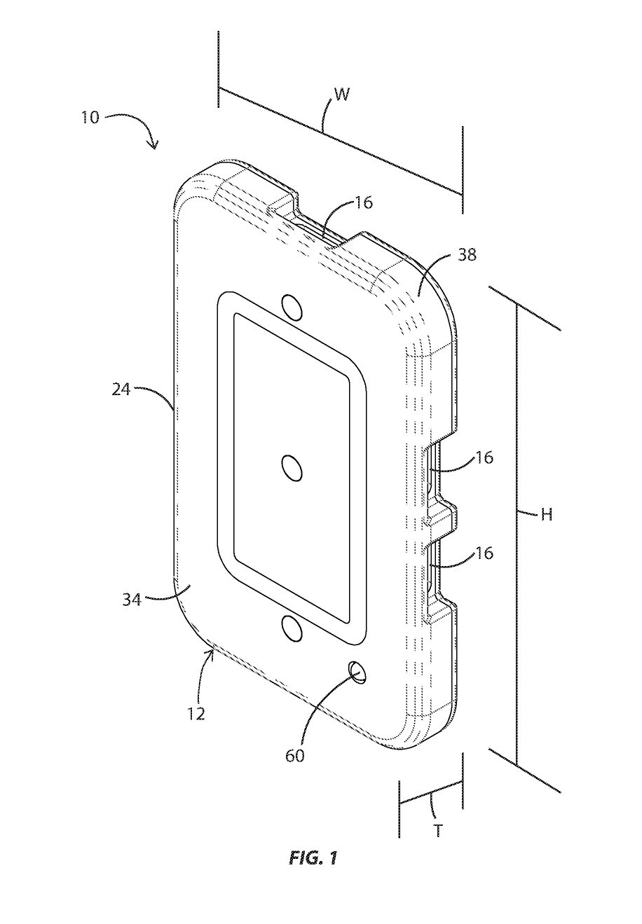

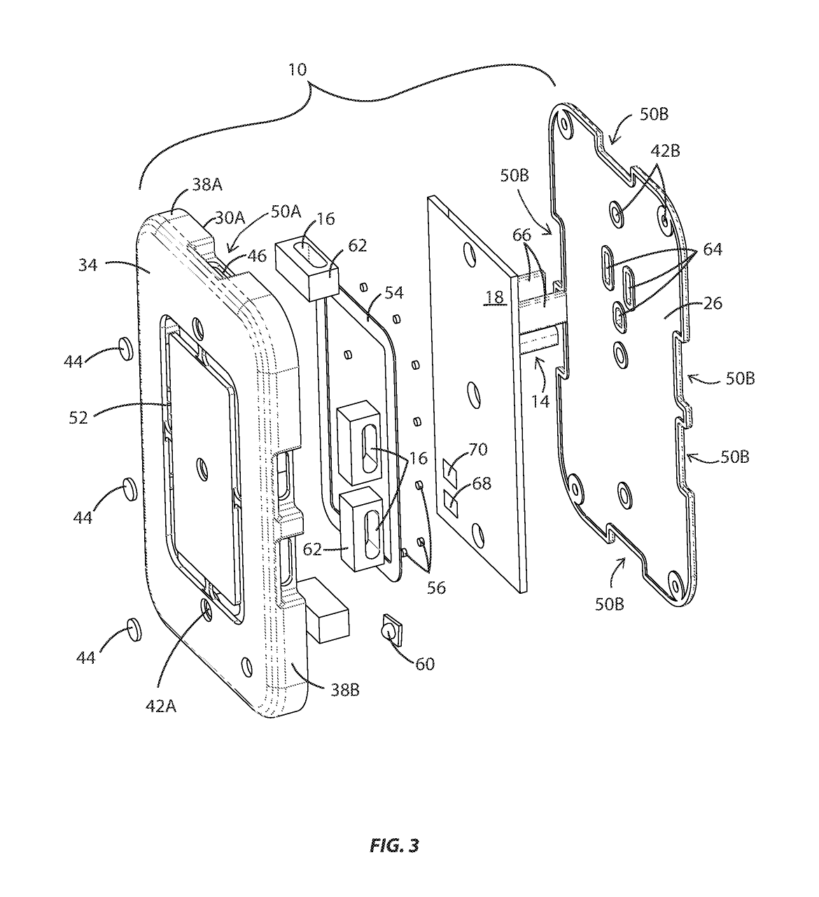

The housing first portion 24 may include a face portion 34 and an edging portion 38. Alternatively, although not shown, the edging portion 38 may be defined by a third housing portion disposed between the first portion 34 and the second portion 38, rather than being defined by the first portion 24. The height H and width W of the housing 12 may be at least substantially defined by the face portion 34 and thickness of the housing 12 may be defined at least substantially defined by the edging portion 38. Put another way, the edging portion 38 may define the housing's outer perimeter. As shown in the figures, the face portion 34 may have a rectangular shape, and may have rounded corners for safety and/or aesthetics. As a non-limiting example, the face 34 portion may have a height of approximately 4.8 inches (±0.5 inch) and a width of approximately 3.0 inches (±0.5 inch). If the housing first portion 24 has curved or non-angular corners (such as those shown in FIGS. 1 and 3), the height H and width W of the housing 12 may be measured at the edging portion 38 (that is, the housing's maximum height and width). The edging portion 38 may have four surfaces 38A-38D that abut the four sides of the at least substantially rectangular face portion and thereby forming the sides of the housing 12. The width of the edging portion 38, which may define the thickness of the housing 12 taken in its entirety, may be approximately 0.5 inch (±0.15 inch). Further, the edging portion 38 may include a free edge that forms the rim or edge 30A of the first portion 24 and that is configured to be coupled to the housing second portion 26. However, it will be understood that the housing 12 may have any suitable dimensions, shape, or configuration, and is not necessarily limited those shown and described herein.

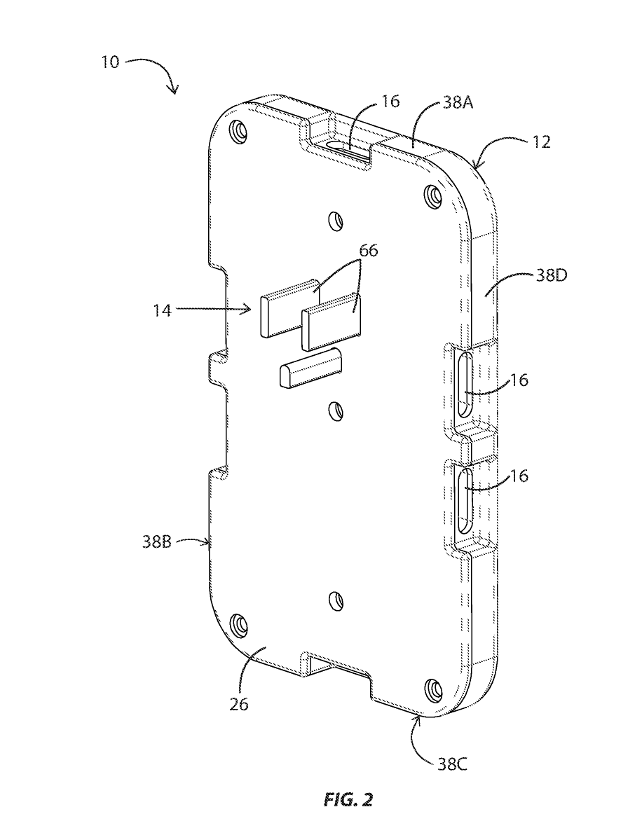

Optionally, the housing first portion 24 may further include one or more apertures 42A in the face portion 34 that are sized and configured to accept screws for coupling the first 24 and second 26 portions together (for example, as shown in FIG. 3). The housing 12 may further include a screw hole plug 44 for each aperture that covers the screw head and is flush with the face portion 34 to create an at least substantially continuous surface. The edging portion 38 may also include one or more connection port apertures 46 that are each associated with a connection port 16 and are sized and configured to accept a male connector, discussed in more detail below. Further, the edging portion 38 may include an indented section 50A at each of the connection port apertures 46 (for example, as shown in FIGS. 1-3). Thus, each connection port 16 may be recessed from the outer edge of the housing 12 (that is, each connection port 16 may be recessed from the surface of the edging portion 38 toward the inner chamber of the housing 12). The face portion 34 of the housing first portion 24 may also include an aperture 52 sized and configured to accept a light transmission window 54. The device 12 may include at least one light source 56 within the interior chamber and in electrical communication with the PCB 18, such as a plurality of light-emitting diodes (LEDs) shown in FIG. 3. The light source(s) 56 may be in electrical communication with the PCB 18. Although the light source(s) 56 may have any size and configuration, as a non-limiting example, the light source(s) 56 may be a plurality of discrete LEDs arranged in least substantially rectangular shape that generally follows the height:width ratio of the housing first portion 24. Further, the aperture 52 and light transmission window 54 may have a similar size and shape in order to maximize the amount of light transmitted through the housing 12 The light transmission window 54 may be composed of an opaque material, but the light source window may be composed of an at least semi-translucent or semi-transparent material through with light from the light source may pass. The face portion 34 may include one or more other light source apertures and/or light source windows, for example, in association with LED indicator lights or other visual elements. Optionally, the device 10 may include an on/off switch or button that allows a user to activate or deactivate the light source 56. As a non-limiting example, a user may activate the light source(s) 56 at night to provide a night light, then deactivate the light source (s) during the day. Additionally or alternatively, the device 10 may include one or more sensors, such as a light sensor 60 that detects changes in light for the automatic activation of the light source(s) 56. The light sensor 60 may be on an outer surface of the housing, an inner surface of the housing within the internal chamber, on the PCB, or at any other suitable location. In the non-limiting example shown in FIG. 3, the light sensor 60 may be at least partially located within the housing interior chamber, and the face portion 34 may include an aperture that allows at least a portion of the sensor 60 to extend therein or that includes an at least semi-translucent or semi-transparent window through which the light sensor 60 may detect changes in ambient light (that is, light external to the housing 12).

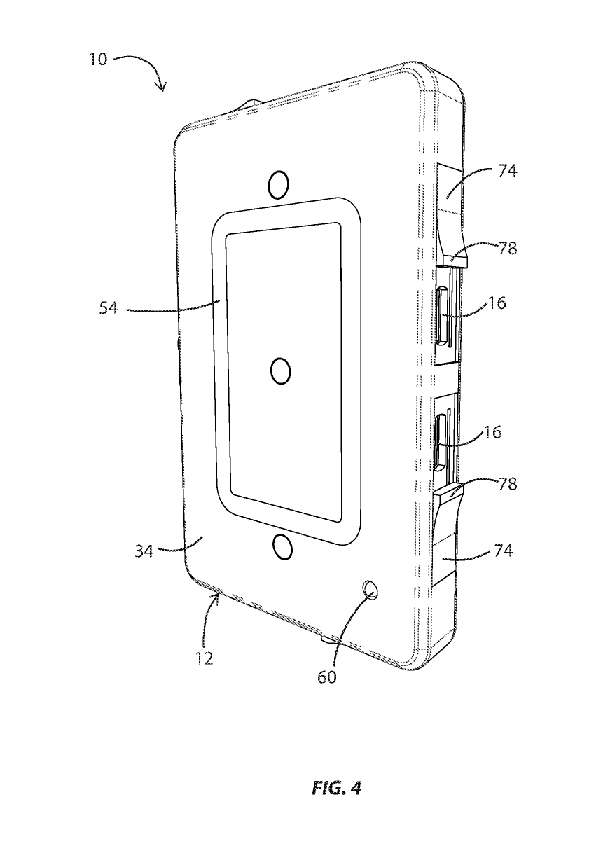

The housing second portion 26 may have at least substantially the same height and width as the housing first portion. The second portion 26 may have a platelike configuration, without an edging portion, and may include a rim or edge 30B that is configured to be coupled to the rim or edge 30A of the housing first portion 24. Additionally or alternatively, the housing second portion 26 may include one or more apertures 42B that are sized and configured to accept screws for coupling the first 24 and second 26 portions. For example, these apertures 42B may be the same size and at the same relative locations as the apertures 42A in the face portion 34 of the first housing portion 24. The second portion 26 may also include one or more recessed or indented sections 50B that correspond to the recessed or indented sections 50A in the edging portion 38 of the housing first portion 24. Put another way, the silhouette of the housing second portion 26 may have one or more indentations. The second portion 26 may further include a plurality of plug apertures 64 that are sized and configured to accept the male connectors or prongs 66 of the plug component 14 that is coupled to the PCB 18, such that the prongs 66 pass through the plug apertures 64 and extend away from the second portion 26. As is shown in FIGS. 4-6, the PCB 18 may include more than one plug component 14 and, therefore, more than one set of plug apertures 64. Further, the plug component 14 may be a standard three-prong or two-prong plug, meaning the plug apertures 64 may be configured likewise.

As noted above, the housing 12 may define an enclosed internal chamber when the first 24 and second 26 portions are coupled together. One or more internal components may be located within this internal chamber, such as the PCB 18, light source(s) 56, and a plurality of connection port housings 62. The PCB 18 may include processing circuitry 68 having a memory and a processor, the memory being in communication with the processor and having instructions that, when executed by the processor, configure the processor perform one or more functions discussed herein. The PCB 18 may also include a wireless communication transceiver 70, such as a WiFi or BLUETOOTH® (Bluetooth Sig, Inc., Delaware) for sending and receiving information. As a non-limited example, the transceiver may be configured to receive information or instructions from a wireless network so that a user may remotely enable or disable the flow of electricity from the power source through the device 10 and into a peripheral device, thereby activating or deactivating the peripheral device. Further, the transceiver may be configured to send information to a remote device (for example, a cell phone, computer, or the like), such as information about energy usage, power surges, etc. Additionally, the transceiver may be configured to send information to and receive information from external devices including, but not limited to, AMAZON ECHO® devices (Amazon Technologies, Inc., Nevada) and GOOGLE HOME® devices (Google Inc., Delaware). The PCB 18 may be coupled to the prongs 66 of the plug component 14 that extend through the plug apertures 64 in the housing second portion 26 and are configured to be plugged into, for example, a standard wall socket. In this way, the device 10 may be in electrical communication with a power source, such as a home or office power supply. The light source (s) 56 and the plurality of connection ports 16 may be in electrical communication with the PCB 18 such that the PCB 18 may activate the light source(s) 56, receive information from one or more peripheral devices connected to the connection ports 16, or the like.

Referring now to FIGS. 4-6, a further configuration of a power source interface device is shown. The device 10 of FIGS. 4-6 is substantially similar to that shown in FIGS. 1-3, except that it includes connection port covers 74 that provide additional safety. Although light a light source is shown in the figures, it will be understood that the device may not include a light source 56.

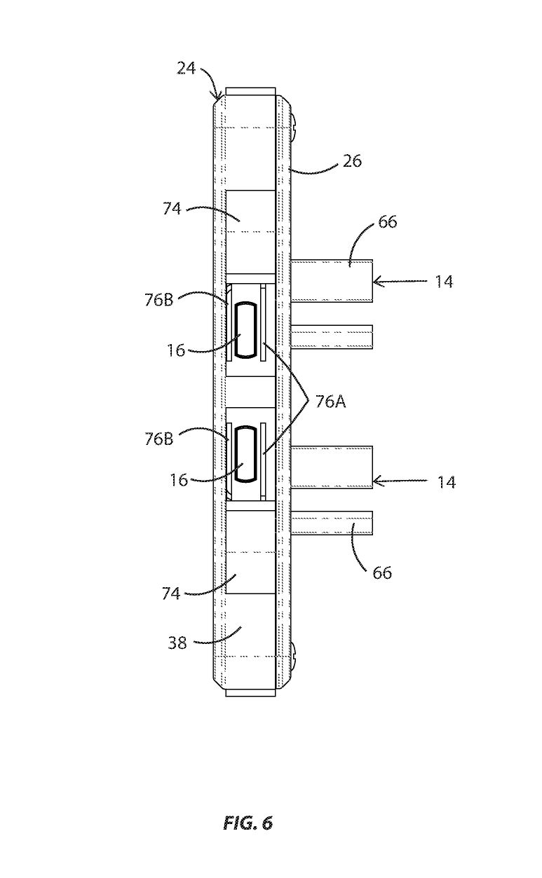

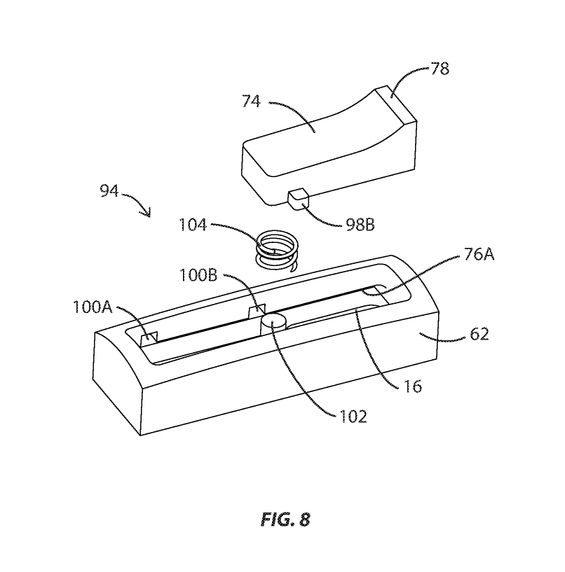

The housing 12 or the connection port housings 16 may define a plurality of tracks 76 with which the connection port covers 74 are engaged. For example, each track 76 may be a groove or an aperture in the material of the corresponding connection port housing 16, and each track 76 may be at least substantially linear (for example, as shown in FIGS. 5 and 6). As a non-limiting example, each connection port housing 62 may define two tracks 76 at least substantially parallel to each other and proximate the connection port 16. As shown in FIG. 6, each connection port housing 62 may include a first track 76A on a first side of each connection port 16 and a second track 76B on a second side of each connection port 16. An exemplary configuration of the connection port covers 74 and tracks 76 is shown and discussed in more detail in FIGS. 8-17. Each cover 74 may have an engagement feature 78 that engages the user's finger to facilitate movement of the cover 74. As a non-limiting example, the engagement feature 78 may be a raised portion, a protrusion, or textural feature such as ridges or bumps that helps the user to exert a force on the cover 74. The cover 74 may be moved by a force acting in a longitudinal direction parallel to the edging portion 38, such as along a distance between the edging portion first 38A and third 38C surfaces, or between the edging portion second 38B and fourth 38D surfaces, depending on the location of the connection port cover 74, to slide the cover 74 between positions. For simplicity, this force may be referred to herein as an activating or activation force.

To keep the connection port covers 74 in place over the connection ports 16, and thereby prevent a child from accessing the connection ports 16 and electrical source, the connection port covers 74 may be configured such that they are depressible and slidable within the tracks 76 only with the application of a threshold amount of pressure. As a non-limiting embodiment, the connection port covers 74 may be configured such that it takes a minimum amount of approximately 125 N±5 N (approximately 28 lbs±2 lbs) of force to depress the cover 74 in order to move the cover 74 from a location in which the cover 74 completely covers (that is, blocks access to or obstructs) the associated connection port 16, which may be referred to as the closed position, to a location in which the connection port 16 is uncovered and accessible (that is, unblocked or unobstructed), which may be referred to as the open position, and vice versa. Data from one study shows that an average five-year-old male child is capable of exerting approximately 55 N±5 N (approximately 13 lbs±2 lbs) with his thumb in either a forward or downward direction, and approximately 30 N±5 N (approximately 7 lbs±2 lbs) with his index finger in either a forward or downward direction. Data from the same study for an average five-year-old female child shows can exert substantially the same force. Therefore, requiring at least 15 pounds of force to move the connection port cover 74 to expose the connection port 16, and therefore make the electrical current accessible, may protect unintended injury to at least children under the age of five. However, the minimum force may be any amount that complies with federal child-resistant product standards, for example, between approximately 5 lbs and approximately 30 lbs or higher. For example, the pounds of force required to move the connection port cover 74 to expose the connection port 16 may be such that not more than 20% of a child test group, after a demonstration, is able to expose the connection ports (for example, in compliance with domestic standards in 16 C.F.R. Part 1700). Likewise, the pounds of force required to move the connection port cover 74 to expose the connection port 16 may be such that at least 90% of a senior-adult test group is able to expose the connection ports (for example, in compliance with domestic standards in 16 C.F.R. Part 1700). Put another way, the power source interface device 10 may be configured such that it is both child resistant and senior adult use effective.

Once the connection port cover 74 is in the open position, a user may insert a plug or other male connector into the connection port 16 of the device 10. Whereas the device's plug component 14 may be either a standard three- or two-prong plug, the connection port 16 may be of any suitable connection type that will put the plugged-in device in electrical communication with the power source. As non-limiting examples, the device 10 may include connection ports 16 of one or more of the following types: universal serial bus (USB, such as, for example, USB Type A, USB Type B, USB Type B 3.0, USB Type C, USB mini A, USB mini B, USB micro A, USB micro B, USB micro B 3.0), Thunderbolt, Thunderbolt 2, Thunderbolt 3, or any other suitable connection type. Further, it will be understood that the device may be configured to accept any suitable connection type, including those that are not yet known at the time of filing.

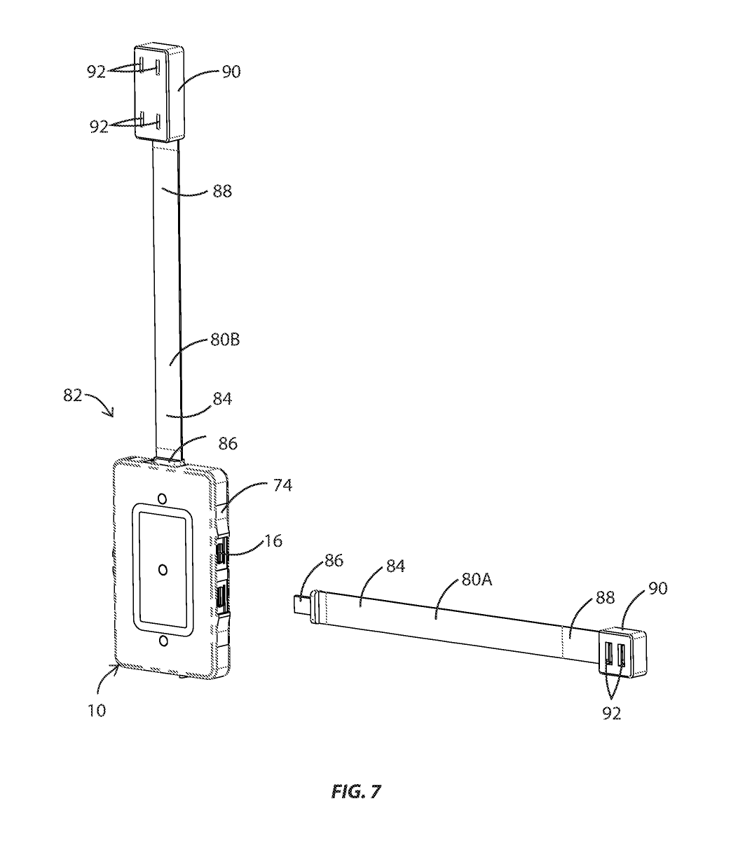

Referring now to FIG. 7, an exemplary power source interface system is shown. The device 10 may be sold individually or as a kit, or may be configured for use with a set of proprietary extension cables 80. In some embodiments, the device 10 may include connection ports 16 that will accept a male connector from a peripheral device without the need for the extension cables. In other embodiments, the device 10 may include connection ports 16 that will accept the male connector only from an extension cable 80. The system 82 shown in FIG. 7 includes a power source interface device 10 and a plurality of extension cables 80. Each extension cable 80 may have a first end 84 with a male connector 86 that is configured to be received by (that is, removably coupled to) a connection port 16 of the device. As a non-limiting example, the male connector 86 may be a USB Type C connector and the connection port 16 may be a USB Type C receptacle. However, it will be understood that other connection types may be used. Each cable 80 may also include a second end 88 with at least one female connection port element 90. The female connection port element 90 may include at least one female connector 92, each of which being adapted to receive a plug or other male connector from a device (which may be referred to as a peripheral device) that is removably connected to the cable 80. In the non-limiting example shown in FIG. 7, a first cable 80A may include a USB-type female connection port element 90 having two standard USB receptacles as the female connectors 92. A USB cable may then be used to connect the peripheral device (for example, an iPhone) to the extension cable 80. Alternatively, in some cases, the peripheral device may be configured to be connected directly to the female connection port element 90 without the use of the peripheral device cable. Each extension cable 80 may have any length of cabling between the first 84 and second 88 ends, and a variety of extension cables 80 with varying lengths may be used at any one time with the device. The extension cable 80 may beneficially provide an easy way to connect peripheral devices to the power source without having to, for example, move furniture to access the wall plug. Electricity may then flow from the power source to the power source interface device 10, through the extension cable 80, through the peripheral device cable (if applicable), and into the peripheral device. Also shown in FIG. 7 is a second extension cable 80B having a female connection port element 90 with two two-prong sockets as the female connectors 92. The system 82 may optionally include as many extension cables as there are connection ports, whether or not sold separately from the power source interface device. Optionally, the female connection port elements 90 may be configured to be affixed or mounted to a surface, such as a wall, a floor, an item of furniture, or other surface so the connection port elements are easily accessible by the user.

Referring now to FIGS. 8-17, an exemplary configuration of a connection port cover assembly is shown in more detail. Specifically, the connection port assembly 94 may include a connection port cover 74 that defines the engagement feature 78, an indentation 96, and at least one protrusion 98. For example, the connection port cover 74 may include a first protrusion 98A on a first side or lateral surface of the cover 74 and a second protrusion 98B on a second side or later surface of the cover 74 opposite the first side. In other words, the first 98A and second 98B protrusions may each extend away from the cover 74 in opposite directions. The connection port housing 62 may include or define a first track 76A, a second track 76B, a first set of notches 100A, a second set of notches 100B located a distance from the first set of notches 100A, and a post 102. Each notch 100A, 100B may have an open end that is in communication with one of the tracks 76A, 76B. For example, one notch of each set of notches 100A, 100B may be in communication with the first track 76A and the other notch of each set of notches 100A, 100B may be in communication with the second track 76B, and each notch 100 may extend in a direction that is approximately 90° from the direction in which the corresponding track extends. The post 102 may extend at least substantially orthogonally away from a surface of the connection port housing 62, such as from a surface of the connection port housing 62 in which the connect port 16 is accessible, and may be slidable along the surface of the connection port housing 62. The indentation 96 may be centered between the protrusions 98A, 98B on a third side (or bottom surface) of the cover 74. That is, the indentation 96 may have a longitudinal axis that is approximately 90° from each of the first and second direction in which the protrusions 98A, 98B extend. Further, the indentation 96 may be sized and configured to receive at least a portion of the post 102 therein (for example, as shown in FIGS. 10, 13, and 16). The connection port cover 74 may be sized and configured to fit within at least a portion of a respective connection port housing 62 and each protrusion 98A, 98B may be sized and configured to slide within the tracks 76A, 76B and fit within one of the notches 100. The connection port assembly 94 may further include a spring 104 that is sized and configured to be positioned over the post 102. Put another way, the spring 104 may be wound around at least a portion of the post 102. Regardless of the position of the cover 74, the spring 104 may be located between the connection port housing 62 and the connection port cover 74, with the first or proximal end of the spring may be in contact with the connection port housing 62 and the second or distal end of the spring may be in contact with the bottom surface of the connection port cover 74. When in use, the connection port cover 74 may be transitionable between an open first position, a depressed second position, and a closed third position.

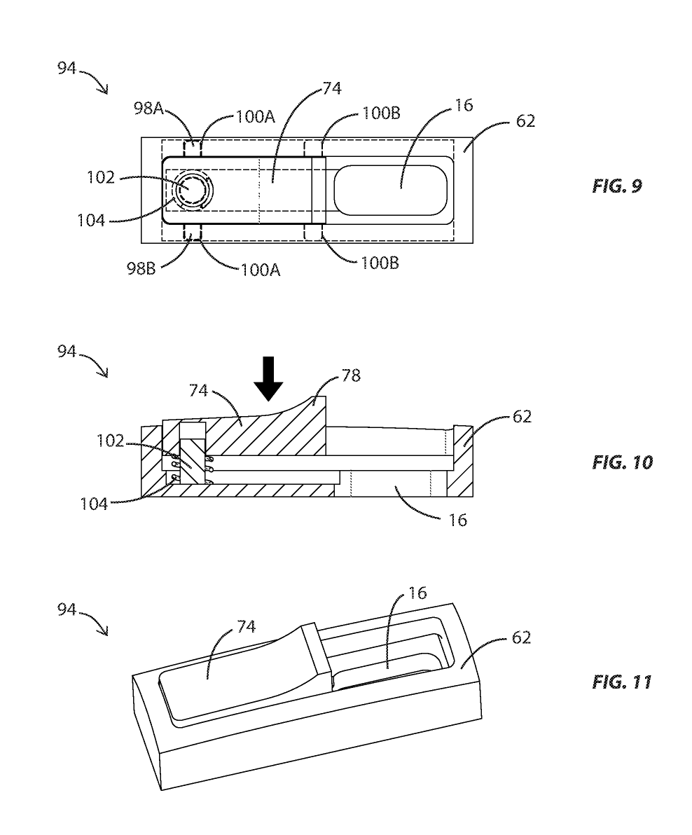

FIGS. 9-11 show the connection port cover assembly in the open first position, with FIG. 9 showing a top view thereof, FIG. 10 showing a cross-sectional view thereof, and FIG. 11 showing a top perspective view thereof. In the first position, the connection port 16 is exposed and accessible. Further, the protrusions 98A, 98B are located within the first set of notches 100A. In this position, the protrusions 98A, 98B are prevented from sliding within the tracks 76A, 76B and, therefore, the connection port cover 74 remains in the open position. The post 102 may include a proximal or first portion 106 that is in contact with the surface of the connection port housing 62 through which the connection port 16 is accessible (for example, as shown in FIG. 10) and a distal or second portion 108 opposite the proximal portion 106. The indentation 96 may be sized and configured to receive at least a portion of post 102 therein. In the first position, at least a portion of the distal portion 108 of the post 102 is within the indentation 96 and the spring 104 is uncompressed.

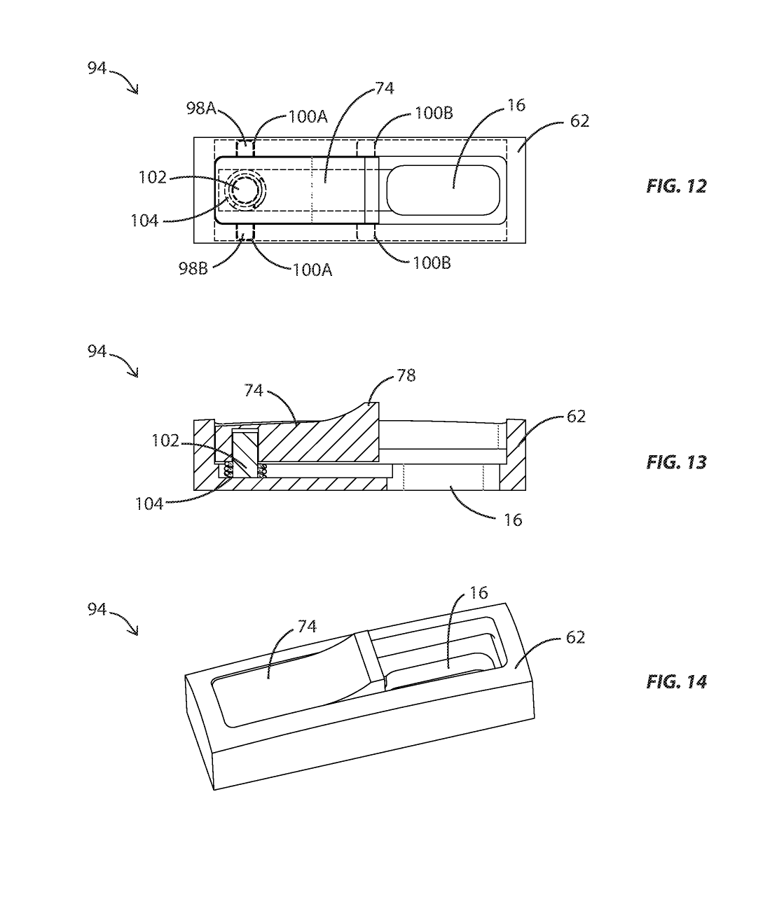

FIGS. 12-14 show the connection port cover assembly in the depressed second position, with FIG. 12 showing a top view thereof, FIG. 13 showing a cross-sectional view thereof, and FIG. 14 showing a top perspective view thereof. In the second position, a depressive force has been applied against a surface of the connection port cover (for example, as shown in FIG. 10). The depressive force may be applied by the user. When the depressive force is applied, the connection port cover 74 may be forced against the spring 104 toward the surface of the connection port housing in which the connection port 16 is accessible, thereby compressing the spring 104 and having a greater amount of the post 102 within the indentation 96. The indentation 96 may be sized and configured such that the post 102 can only move linearly within the indentation 96 along the longitudinal axis of the post 102. Further, the protrusions 98A, 98B may move in a first direction within the first set of notches 100A to position the cover 74 such that the protrusions 98A, 98B are aligned with the tracks 76A, 76B. As noted above, it may take a threshold amount of pressure to compress the spring 104 enough to align the protrusions 98A, 98B with the tracks 76A, 76B, and thereby position the cover to be moved to the open third position. As a non-limiting example, the spring 104 may be constructed to have a spring rate that requires at least 5 pounds of force (for example, approximately 15 pounds of force) to sufficiently depress the connection port cover 74. Additionally, the spring 104 may have a height that is less than the height of the post 102. Thus, when the spring 104 is uncompressed, at least a portion of the connection port cover 74 may be in contact with the spring 104 while at least a portion of the post 102 is within the indentation 96 of the cover 74. The depressed second configuration may also be referred to herein as the transition configuration, as it may take the same amount of depressive force to compress the spring 104 to transition the cover 74 from the closed third position to the depressed second position as it takes to transition the cover 74 from the open first position to the depressed second position.

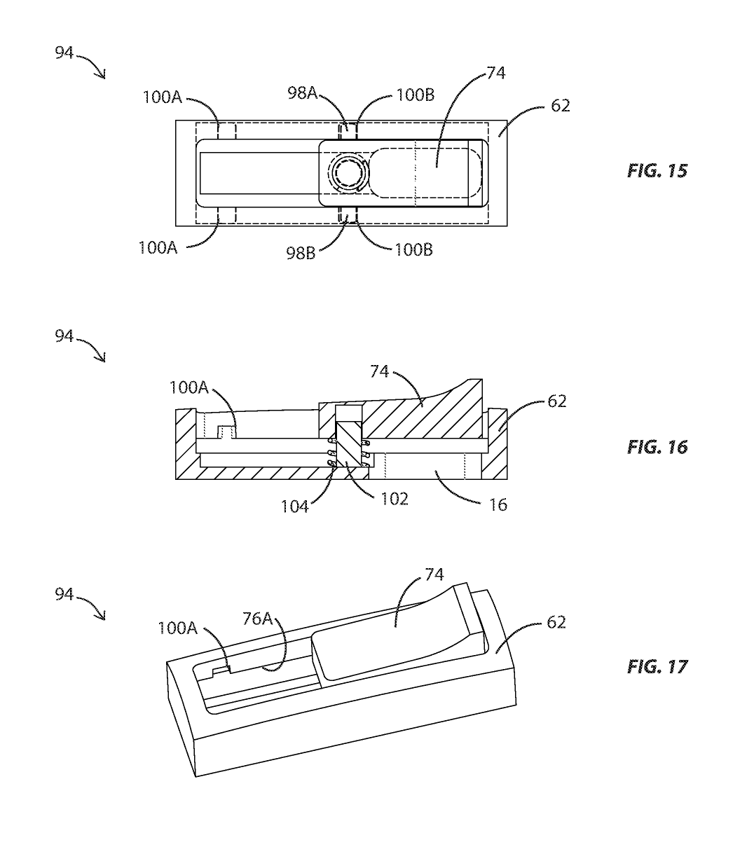

FIGS. 15-17 show the connection port cover assembly in the closed third position, with FIG. 15 showing a top view thereof, FIG. 16 showing a cross-sectional view thereof, and FIG. 17 showing a top perspective view thereof. In the third position, the connection port cover 74 may be slid such that the protrusions 98A, 98B move linearly within and along the tracks 76A, 76B to cover or obstruct the connection port 16. For example, the cover 74 may be moved such that the protrusions 98A, 98B travel a distance from the first set of notches 100A to the second set of notches 100B. As the cover 74 moves linearly, the post 102, which is at least partially within the indentation 96, may be likely moved along the surface of the connection port housing 62. When the connection port cover 74 has covered or obstructed the connection port 16, the depressive force against the cover 74 may be released, allowing the spring 104 to decompress and causing the protrusions 98A, 98B to move in a second direction, opposite the first direction, within the second set of notches 100B. The notches 100B are sized and configured such that the protrusions 98A, 98B can move therein only in the first and second directions (that is, to compress or decompress the spring 104). Unless a subsequent depressive force is applied, the connection port cover 74 will remain locked in the closed third position, due to the configuration of the connection port cover assembly shown and described herein.

It is to be understood that the above description is intended to be illustrative, and not restrictive. For example, the above-described embodiments (and/or aspects thereof) may be used in combination with each other and the drawings are not necessarily to scale. In addition, may modifications may be made to adapt to a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. In the appended embodiment, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects.

Different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the specification, including the drawings, shall be construed to constitute a complete written description of all combinations and subcombinations of the embodiments described herein, and of the manner and process of making and using them, and shall support claims to any such combination or subcombination.

1. A device for connecting to a power source, the device comprising:
a housing including a first surface, a second surface opposite the first surface, and a third surface between the first and a second surfaces, the first, second, and third surfaces defining a housing interior chamber;
at least one plug component extending from the second surface;
at least one connection port in the third surface;
at least one connection port cover, each of the at least one connection port cover being configured to selectively obstruct and unobstruct a corresponding one of the at least one connection port in response to a force acting in a longitudinal direction parallel to the third surface; and
a circuitry component within the housing interior chamber.

2. The device of claim 1, wherein the housing further includes a first portion and a second portion, the first portion defining the first surface of the housing and the second portion defining the second surface of the housing.

3. The device of claim 2, wherein the first portion further defines the third surface.

4. The device of claim 2, wherein the at least one plug component has a plurality of prongs and the second portion has a plurality of plug apertures, each of the at least one plurality of prongs extending through a corresponding one of the plurality of plug apertures.

5. The device of claim 1, wherein at least a portion of the plug component is coupled to the circuit component.

6. The device of claim 1, further comprising a light source at least partially within the housing interior chamber.

7. The device of claim 6, wherein the housing further includes a light transmission window and the first surface has an aperture sized and configured to accept at least a portion of the light transmission window.

8. The device of claim 6, wherein the light source includes a plurality of light emitting diodes.

9. The device of claim 1, wherein each of the at least one connection port cover includes an engagement feature that is engageable with a finger of a user to facilitate movement of the connection port cover.

10. The device of claim 9, wherein the at least one connection port includes a plurality of connection ports and the at least one connection port cover includes a plurality of connection port covers.

11. The device of claim 10, wherein each of the plurality of connection port covers is configured to move between a first location in which the associated one of the plurality of connection ports is unobstructed and a second location in which the associated one of the plurality of connection ports is obstructed by an application of a minimum amount of depressive force on each of the plurality of connection port covers.

12. The device of claim 11, wherein the minimum amount of force is at least 5 lbs.

13. The device of claim 11, wherein the minimum amount of force is approximately 15 lbs.

14. The device of claim 10, wherein each of the at least one connection port has a corresponding connection port housing, each connection port housing having a plurality of tracks.

15. The device of claim 14, wherein each of the plurality of tracks is at least substantially linear.

16. The device of claim 15, wherein the plurality of tracks includes a first track on a first side of a corresponding connection port and a second track on a second side opposite the first side of the corresponding connection port.

17. The device of claim 15, wherein at least a portion of each of the plurality of connection port covers is configured to be accepted within a corresponding one of the plurality of tracks.

18. A device for connecting to a power source, the device comprising:
at least one electrical connection port; and
at least one electrical connection port assembly at each of the at least one electrical connection port, each of the at least one electrical connection port assembly including:
an electrical connection port housing having a first track and a second track at least substantially parallel to each other, the first track being on a first side of the electrical connection port and the second track being on a second side of the electrical connection port;
an electrical connection port cover having a first protrusion extending away from the electrical connection port cover in a first direction, a second protrusion extending away from the electrical connection port cover in a second direction opposite the first direction, an indentation between the first and second protrusions, the first protrusion being configured to move linearly within the first track and the second protrusion being configured to move linearly within the second track;
a post that is slidable relative to the electrical connection port housing, the post being sized and configured such that at least a portion of the port is received within the indentation of the electrical connection port cover; and
a spring between the electrical connection port housing and the electrical connection port cover, the spring being wound around at least a portion of the post, the spring having a spring rate that requires a threshold amount of force to compress the spring,
each of the at least one electrical connection port cover assembly being configured such that the electrical connection port cover compresses the spring and moves toward the electrical connection port when a depressive force is applied on the electrical connection port cover.

19. The device of claim 19, wherein each of the at least one electrical connection port housing further includes a first set of notches in communication with the first and second tracks and a second set of notches a distance from the first set of notches and in communication with the first and second tracks, the first and second protrusions being configured to be:
located within the first set of notches when the spring is uncompressed and the electrical connection port is unobstructed by the electrical connection port cover; and
located within the second set of notches when the spring is uncompressed and the electrical connection port is obstructed by the electrical connection port cover.

20. A kit for connecting a peripheral device to a power source, the kit comprising:
a power source interface device including:
a housing having a first surface, a second surface opposite the first surface, and a third surface between the first and a second surfaces, the first, second, and third surfaces defining a housing interior chamber;
at least one plug component extending from the second surface;
at least one connection port in the third surface; and
at least one connection port cover, each of the at least one connection port cover being configured to selectively obstruct and unobstruct a corresponding one of the at least one connection port in response to a force acting in a longitudinal direction parallel to the third surface; and
at least one extension cable, each of the at least one extension cable including:
a first end and a second end opposite the first end;
a male connector at the first end; and
a female connection port element at the second end,
the male connector being configured to be accepted within a corresponding one of the at least one connection port.
